(19) United States
(12) Patent Application Publication
(10) Pub. No.: US 2003/0113571 A1
(43) Pub. Date: Jun. 19, 2003

(54) Strong and dimensionally stable wood panel assembly and method of fabrication thereof

(76) Inventors: Yvon Lavoie, Montreal (CA); Alex Nadezhdin, Beaconsfield (CA); Andrew T. Go, Kirkland (CA); Alain Laplante, Senneterre (CA)

Correspondence Address: MEREK & VOORHEES, 643 B South Washington, Alexandria, VA, 22314, US

(21) Appl. No.: 10/013,484

(22) Filed: Dec. 13, 2001

(51) Int. Cl. B32B 29/00; B32B 21/04

(52) U.S. Cl. 428/535; 264/320; 428/537.1

(57) ABSTRACT

A method for fabricating a wood panel assembly comprising the acts of providing a steam-treated wood panel assembly comprising two faces and a core submitting the steam-treated wood panel assembly to an elevated pressure under an elevated temperature so as to decrease its thickness is described herein. Also described herein is a wood panel assembly having a high strength and a high resistance to swelling under moisture. The assembly comprises two faces, each of the faces having an outer surface; and a core provided between the two faces. The wood panel assembly, after a steam-treatment, is submitted to a high pressure under an elevated temperature to yield the high strength and high resistance to swelling under moisture properties.

### FIELD OF THE INVENTION

The present invention relates to wood panel assemblies. More specifically, the present invention is concerned with a wood panel assembly characterized by a high strength combined with a high resistance to swelling, and with a method of fabrication thereof.

### BACKGROUND OF THE INVENTION

Oriented strand boards, oftentimes referred to as OSBs, are common wood panel assemblies, conventionally made of two outermost layers, or faces, and a central layer, or core. The three layers are usually made simultaneously by pressing a mat of flat elongated wood wafers or flakes blended with a small amount of a thermoset resin and other additives, under conditions of high pressure and high temperature.

A widespread concern in the field of OSB technology is their dimensional unstability against swelling when the humidity increases.

Current methods of wood panel assembly dimensional stabilization include steam-treating the fibre mat after the panel is made (see for example U.S. Pat. No. 6,098,679 to Go and al.), or steam-treating the wafers prior to the wood panel assembly pressing.

However, some of the mechanical properties of the wood panel assembly are generally decreased as a consequence of the above-mentioned methods of dimensional stabilization. In particular, the modulus of elasticity, or Young modulus, (MOE or E), and the modulus of rupture (MOR) are significantly reduced in the treated wood panel assemblies compared to their values before the wood panel assemblies are steam-treated for dimensional stabilization.

It can be further observed that the reduction of stiffness of the board, which is defined by the product E×I where I is the moment of inertia of the board, is mostly related to the decrease in E (or MOE). Thus, while an increase in thickness as that resulting from the conventional steam-treatment could be expected to increase the overall stiffness of the wood panel assembly, in reality induces a decrease in the panel density, and therefore a lower resistance to elongation of the faces and hence a weakening of the mechanical properties of the wood panel assembly. Indeed, the theory of mechanics of materials teaches that the resistance to elongation and the tensile rupture of the faces of a wood panel assembly are responsible for the overall bending strength of the wood panel assembly.

It can thus be readily appreciated that provision of a wood panel assembly that is dimensionally stabilized while keeping high strength parameters, at a reasonable cost, would be a highly desirable advance over the current state of wood panel assembly technology.

### OBJECTS OF THE INVENTION

The general object of the present invention is to provide a strong and dimensionally stable wood panel assembly and a method of fabrication thereof.

### SUMMARY OF THE INVENTION

More specifically, in accordance with the present invention, there is provided a method for fabricating a wood panel assembly comprising the acts of:

providing a steam-treated wood panel assembly comprising two faces and a core;

submitting said steam-treated wood panel assembly to an elevated pressure under an elevated temperature so as to decrease its thickness.

According to another aspect of the invention, there is provided a method for making a high bending strength and dimensionally stable wood panel assembly comprising two faces and a core, including the act of submitting a steam-treated wood panel assembly comprising two faces and a core to an elevated pressure and an elevated temperature in a press so as to cause a densification of the faces.

According to another aspect of the present invention, there is provided a method for making a high bending strength and dimensionally stable wood panel assembly comprising two faces and a core, based on re-processing a dimensionally stable wood panel assembly comprising two faces and a core by subjecting it to a compression under an elevated pressure and an elevated temperature, so as to reduce its thickness.

According to a final aspect of the present invention, there is provided a wood panel assembly having a high strength and a high resistance to swelling under moisture, said assembly comprising:

two faces, each of said faces having an outer surface; and

a core provided between said two faces;

wherein said wood panel assembly, after a steam-treatment, is submitted to a high pressure under an elevated temperature to yield the high strength and high resistance to swelling under moisture properties.

Other objects, advantages and features of the present invention will become more apparent upon reading of the following non-restrictive description of preferred embodiments thereof, given by way of example only with reference to the accompanying drawings.

### BRIEF DESCRIPTION OF THE DRAWINGS

In the appended drawings:

FIG. 1 is a block diagram indicating the steps of the method of fabrication of a wood panel assembly according to an embodiment of the present invention;

FIG. 2 is a cross sectional view of a steam-treated wood panel assembly as is found in the prior art, and

FIG. 3 is a cross sectional view of wood panel assembly made according to the method of FIG. 1.

### DESCRIPTION OF THE PREFERRED EMBODIMENT

Generally stated, the present invention is concerned with a method for providing a wood panel assembly combining high bending and rupture strengths together with a high resistance to swelling under high humidity conditions, and to such a panel.

More precisely, the present method involves re-processing dimensionally stabilized wood panel assemblies, which have been steam-treated for purpose of dimensional stabilization according to methods known in the art, as described for example in U.S. Pat. No. 6,098,679 to Go et al., which is hereby included by reference, so as to achieve densification of their faces, thus achieving increased bending and rupture strengths.

In particular, the method of the present invention comprises pressing steam-treated wood panel assemblies under an elevated pressure and an elevated temperature, so as to reduce their thickness.

It is found that such a second pressing causes a restoration of the faces density, resulting in an increased tensile strength of the faces, which in turn results in an increase of the bending strength of the wood panel assembly.

As a way of example, a steam-treated 19-mm thick OSB board, fabricated in the conventional way, is submitted to a second pressing at about 200° C. for about 60 seconds under a pressure of about 3 KPa. In this period of time, the wood panel sees its thickness reduced from about 19 mm to about 18 mm. The final thickness is controlled by means of steel spacers located between the platens of the press to prevent over-pressing.

From Table 1, it can be seen that, as a result of this second pressing, the strength the OSB board is increased by 17%. MOEₚₐᵣₐ is the modulus of elasticity is measured in a direction parallel to the orientation of the wafers in the faces.

TABLE 1

| | MOEₚₐᵣₐ | Change |
|---|---|---|
| Sample | (MPA) | (%) |
| Steam-treated board before 2^{nd} | 4531 | — |
| pressing | | |
| Steam-treated board after 2^{nd} pressing | 5305 | +17 |

It is to be noted that a subsequent testing by immersion in water of a re-pressed wood panel assembly made from a steam-stabilized wood panel assembly precursor demonstrates that the resistance to swelling imparted by the steam treatment remains after the second pressing.

Therefore, it is shown that while the mechanical strength is restored, the dimensional stability, achieved by the traditional steam-treatment, is preserved, so that the re-pressed wood panel assembly made from a steam-stabilized wood panel assembly combines dimensional stability and mechanical strength.

Additionally, it is found that an additional reinforcement of the re-pressed wood panel assembly made from a steam-stabilized wood panel assembly can be obtained by adding a resin binder on the outer surface of at least one of the two faces of the steam-treated wood panel assembly prior to re-processing it according to the steps described hereinafter.

This is achieved, for example, by depositing either a layer of resin binder, or a binder-impregnated paper, on the outer surface of at least one of the faces of the steam-treated wood panel, before performing the second pressing.

For example, a test is conducted using 50 cm×10 cm×1.8 cm samples of commercial dimensionally stabilized wood panel assemblies. Sheets of phenol-formaldehyde resin-impregnated paper are placed on the outer surface of each one of the faces of the sample prior to submitting it to a second pressing at about 175° C. for about 5 minutes, under a pressure of about 3 KPa.

The test is repeated on the same type of commercially dimensionally stabilized wood panel assembly, depositing a layer of resin, instead of a resin-impregnated paper, on the outer surface of each one of the faces of the steam-treated wood panel assembly. More precisely, a viscous solution containing about 50% resin is brushed on the outer surface of the faces before the steam-treated wood panel assembly is placed in the press. The same conditions are applied, namely a temperature of about 175° C. for about 5 minutes, under a pressure of about 3 KPa.

The results of the above two tests are displayed in Table 2. In both cases, the desired target thickness of the final wood panel assembly is controlled by means of steel spacers in the closing gap of the press to prevent over-pressing. The results are assessed by measuring the wood panel assembly resistance to bending. More precisely, the standard modulus of elasticity is measured in a direction parallel to the orientation of the wafers in the faces, yielding MOEₚₐᵣₐ.

TABLE 2

| | | Thickness | | |
|---|---|---|---|---|
| Example | | reduction | MOEₚₐᵣₐ | Change |
| (#) | Description | (mm) | (MPa) | (%) |
| — | Steam-treated board | — | 6350 | — |
| | before pressing (control) | | | |
| 2 | 2nd pressing with | 1 | 7905 | +24 |
| | Phenolic paper on both | | | |
| | faces | | | |
| 3 | 2nd pressing with | 3 | 8960 | +41 |
| | Phenolic paper on both | | | |
| | faces | | | |
| 4 | 2nd pressing with the | 3 | 8966 | +41 |
| | layer of resin deposited on | | | |
| | the faces | | | |

By comparison of the results in Table 1 and in Table 2, it appears that the increase in MOEₚₐᵣₐ is related to the reduction in thickness (which corresponds to an increase in face density) achieved for the second pressing at high temperature: a larger reduction of the thickness of the wood panel assembly induces a larger increase of MOEₚₐᵣₐ.

It is believed that the improved properties obtained by the method of the present invention can be attributed to a higher degree of densification of the faces in the final wood panel assembly. The effect of this re-processing of a steam-treated wood panel assembly is essentially to reduce the thickness of the wood panel assembly, in the range of about one millimeter or more. Thus, this method also enables to compensate for the slight increase in thickness of the wood panel assembly caused by the steam-treatment that is usually performed for achieving dimensional stabilization.

Moreover, it is found that the addition of resin, either under the form of resin-impregnated paper or of diluted resin, on the outer surface of at least one of the faces of the wood panel assembly before the re-processing described hereinabove has a further reinforcing effect.

One exemplary embodiment of the method for fabricating a wood panel assembly in accordance with the present invention will now be summarized with reference to the appended Figures.

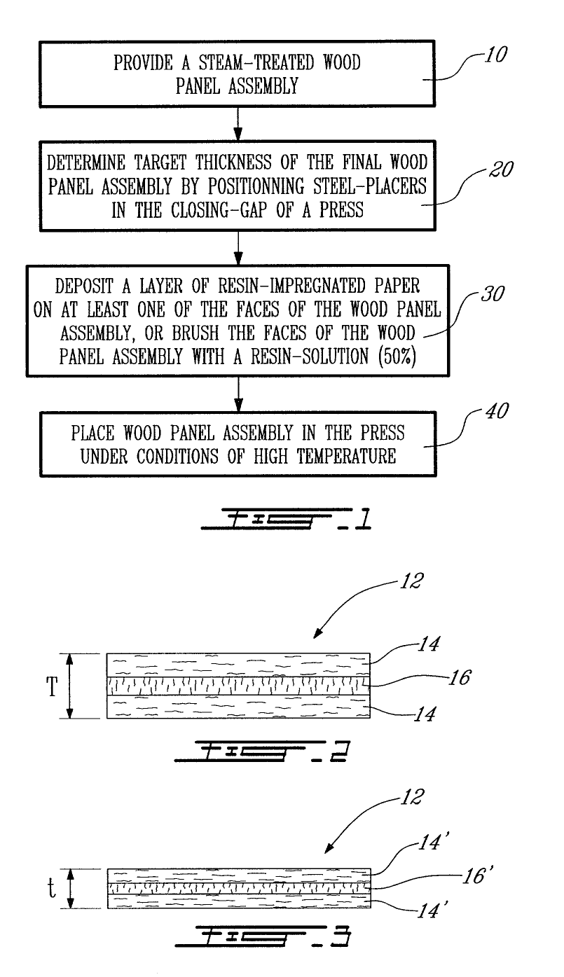

The main steps of the method according to an embodiment of the present invention are shown in FIG. 1.

In a first step 10, a steam-stabilized wood panel assembly is provided. As can be seen from FIG. 2, the wood panel assembly 12 traditionally comprises two faces 14, and a core 16. This steam-stabilized wood panel assembly 12 has a first thickness labeled “T”.

In step 20, steel spacers are positioned in the closing-gap of a manual press according to a desired target thickness “t” of the final wood panel assembly. In the case of an automatic press, the press closing-gap is set automatically to the desired target thickness. Then, in step 40, the steam-stabilized wood panel assembly 12 is placed inside the press, under conditions of elevated pressure preferably in the range between about 1.4 KPa and about 4 KPa, and high temperature, preferably in the range between about 130° C. and about 200° C.

Generally speaking, the conditions in the press can be varied between a minimum temperature of 130° C. and a minimum pressure of 1.4 Pa, as generally required for bonding phenolic resin-impregnated paper, and values of temperature and pressure as high as 200° C. and 4 KPa respectively, so as to achieve the desired overall thickness reduction of the wood panel assembly.

In an additional optional step 30, a layer of resin-impregnated paper (not shown) may be deposited on the outer surface of one (or both) of the faces of the wood panel assembly 12 before placing the wood panel assembly 12 inside the press for re-processing (step 40). Alternatively, the outer surface of the faces of the wood panel assembly may be brushed with a solution of resin (not shown), before placing the wood panel assembly inside the press and performing the pressing under the above-mentioned conditions of pressure and temperature. It has been found that a solution of resin diluted in water by 50% is adequate.

Of course, one skilled in the art will understand that the addition of the resin to the surface(s) of the faces can take many other forms. For example, the resin could be added in the form of a powder or resin-impregnated cloth.

As a result, the resulting second pressed wood panel assembly 12′, shown in FIG. 3, is obtained, comprising two faces 14′ and a core 16′, the overall thickness of which, referred to as “t”, is reduced compared to the thickness “T” of the initial steam-treated wood panel assembly 12 of FIG. 2 resulting from a dimensional stabilization treatment commonly performed in the art.

People in the art will foresee benefits of using resin-impregnated paper or a layer of resin binder on the outer surface of the faces of the wood panel assembly, in the making of a wood panel assembly provided with a smooth and water impermeable surface. Such finish of the surface of a wood panel assembly can be desirable in some practical applications, such as concrete forming.

Interestingly, the wood panel assembly achieved with such mechanical strength combined with dimensional stability may be used in a line of products intended for severe service conditions, such as concrete form board, outdoor wall sliding, temporary pavement, deck flooring in heavy traffic areas, and the likes.

As will easily be understood by one skilled in the art, many types of resin can be used. For example, the resin can be phenol-formaldehyde and its derivatives, melanin and its derivatives, MDI (methylene-di-isocyanate) and its derivatives, or other suitable thermoset resin, or their combinations.

It is also to be noted that plain water may also be brushed on at least one of the surfaces of the faces before the pressing.

Although the present invention has been described hereinabove by way of preferred embodiments thereof, it can be modified, without departing from the spirit and nature of the subject invention as defined in the appended claims.

What is claimed is:

1. A method for fabricating a wood panel assembly comprising the acts of:
providing a steam-treated wood panel assembly comprising two faces and a core;
submitting said steam-treated wood panel assembly to an elevated pressure under an elevated temperature so as to decrease its thickness.

2. A method according to claim 1, wherein said steam-treated wood panel assembly providing act includes the sub-act of adding resin on an outer surface of at least one of the two faces of the steam-treated wood panel assembly.

3. A method according to claim 2, wherein said resin adding sub-act includes adding liquid resin thereto.

4. A method according to claim 2, wherein said resin adding sub-act includes adding resin powder thereto.

5. A method according to claim 2, wherein said resin adding sub-act includes depositing a resin-impregnated cloth thereto.

6. A method according to claim 2, wherein said resin adding sub-act includes depositing a layer of resin-impregnated paper thereto.

7. A method according to claim 1, wherein said resin adding sub-act includes brushing a resin-concentrated solution thereon.

8. A method according to claim 1, wherein said steam-treated wood panel assembly providing act comprises the sub-act of applying water on the outer surface of at least one of the two faces of the steam-treated wood panel assembly.

9. A method according to claim 1, wherein said elevated pressure is in the range of about 2 Kpa to about 4 Kpa and wherein said elevated temperature is in the range of about 130° C. to about 200° C.

10. A method for making a high bending strength and dimensionally stable wood panel assembly comprising two faces and a core, including the act of submitting a steam-treated wood panel assembly comprising two faces and a core to an elevated pressure and an elevated temperature in a press so as to cause a densification of the faces.

11. A method for making a high bending strength and dimensionally stable wood panel assembly comprising two faces and a core, based on re-processing a dimensionally stable wood panel assembly comprising two faces and a core by subjecting it to a compression under an elevated pressure and an elevated temperature, so as to reduce its thickness.

12. A method as recited in claim 11, wherein said thickness is reduced by at least one millimeter.

13. A wood panel assembly having a high strength and a high resistance to swelling under moisture, said assembly comprising:
two faces, each of said faces having an outer surface; and
a core provided between said two faces;
wherein said wood panel assembly, after a steam-treatment, is submitted to a high pressure under an elevated temperature to yield the high strength and high resistance to swelling under moisture properties.

14. A wood panel assembly according to claim 13, wherein said wood panel assembly has a first thickness after the steam-treatment and a second thickness after the high pressure submission; said second thickness being thinner than said first thickness.

15. A wood panel assembly as recited in claim 14, wherein said second thickness is reduced by at least one millimeter compared said first thickness.

16. A wood panel assembly according to claim 13, further comprising a resin binder on said outer surface of at least one of said faces.

17. A wood panel assembly according to claim 16, wherein said resin is selected from the group consisting of phenol-formaldehyde and its derivatives, melanin and its derivatives, MDI (methylene-di-isocyanate) and its derivatives, thermoset resin and combinations thereof.
